(19) United States
(12) Patent Application Publication
(10) Pub. No.: US 2026/0361630 A1
(43) Pub. Date: Nov. 12, 2026

(54) PERFORMANCE PREDICTION OF AN APPLICATION SESSION

(71) Applicant: Juniper Networks, Inc., Sunnyvale, CA (US)

(72) Inventors: Randall W. Frei, Sunnyvale, CA (US); Vivek Vijaykumar, Fremont, CA (US); Navraj Pannu, Palo Alto, CA (US); Suresh Kumar Nalluru, San Jose, CA (US); Pavol Skubak, Pezinok (SK); Indrajit Baruah, Bengaluru (IN)

(21) Appl. No.: 19/664,725

(22) Filed: Apr. 30, 2026

(30) Foreign Application Priority Data
May 7, 2025 (IN) 202541044252

(51) Int. Cl. H04L 43/08

(52) U.S. Cl. CPC H04L 43/08

(57) ABSTRACT

In general, techniques are described for predicting one or more application performance metrics of an application session for a site without data associated with an application session. For example, a network management system estimates, based on data of a first site with application data, a value for each of one or more features for a second site without application data. The network management system determines, based on the estimated value for each of the one or more features for the second site, one or more application performance metrics of an application session for the second site.

This application claims the benefit of India Provisional Application No. 202541044252, filed 7 May 2025, the entire contents of which is incorporated herein by reference.

### BACKGROUND

Commercial premises or sites, such as offices, hospitals, airports, stadiums, or retail outlets, often install complex wireless network systems, including a network of wireless access points (APs), throughout the premises to provide wireless network services to one or more wireless client devices (or simply, “clients”). APs are physical, electronic devices that enable other devices to wirelessly connect to a wired network using various wireless networking protocols and technologies, such as wireless local area networking protocols conforming to one or more of the IEEE 802.11 standards (i.e., “Wi-Fi”), Bluetooth / Bluetooth Low Energy (BLE), mesh networking protocols such as ZigBee or other wireless networking technologies. Many different types of wireless client devices, such as laptop computers, smartphones, tablets, wearable devices, appliances, and Internet of Things (IoT) devices, incorporate wireless communication technology and can be configured to connect to wireless access points when the device is in range of a compatible wireless access point in order to access a wired network. In the case of a client device running a cloud-based application, such as voice over Internet Protocol (VoIP) applications, streaming video applications, gaming applications, or video conference applications, data is exchanged during an application session from the client device through one or more APs and one or more wired network devices, e.g., switches, routers, and/or gateway devices, to reach an application server.

### BRIEF DESCRIPTION OF DRAWINGS

FIG. 1 is a block diagram of an example network system including a network management system to predict one or more application performance metrics of an application session for a site without application data, in accordance with one or more techniques of the disclosure.

FIG. 2 is a block diagram of an example access point device, in accordance with one or more techniques of this disclosure.

FIG. 3A is a block diagram of an example network management system configured to predict one or more application performance metrics of an application session for a site without application data, in accordance with one or more techniques of the disclosure.

FIG. 3B is a block diagram of an application performance prediction engine of the network management system of FIG. 3A.

FIG. 4 is a block diagram of an example user equipment device, in accordance with one or more techniques of this disclosure.

FIG. 5 is a block diagram of an example network node, in accordance with one or more techniques of this disclosure.

FIG. 6 illustrates an example user interface, in accordance with the techniques of this disclosure.

FIG. 7 illustrates a block diagram of an example a backend pipeline of the application performance prediction engine, in accordance with the techniques of this disclosure.

FIG. 8 illustrates a block diagram of an example operation to predict one or more application performance metrics of an application session for a site without application data, in accordance with one or more techniques of the disclosure.

FIG. 9 is a flowchart of an example operation of a network management system to predict one or more application performance metrics of an application session for a site without application data, in accordance with one or more techniques of the disclosure.

### DETAILED DESCRIPTION

In general, this disclosure describes one or more techniques for a network management system (NMS) to predict one or more application performance metrics of an application session for a site without application data, in accordance with one or more techniques of this disclosure. For example, a site may implement an application session for a cloud-based application (e.g., a VoIP or video conference call, a streaming video viewing session, or a gaming session). During the application session, a client device at the site may exchange data through one or more access point (AP) devices, one or more switches, and/or other network devices of the site to reach the cloud-based application server that hosts the application provided by a third-party application service provider. An NMS may typically obtain data associated with the application session (referred to herein as “application data”), such as network data of one or more network devices associated with the application session and application performance data associated with the application session, to train a predictive model (e.g., a machine learning (ML) model) to determine a root cause of a predicted issue to an application session and/or to predict one or more application performance metrics of the application session. For example, the NMS may obtain network data of network devices associated with the application session, such as signal strength (RSSI), jitter, transmission bytes, radio utilization, total number of clients per AP, number of APs per site, CPU utilization of a client device, information associated with a VPN session, etc. The NMS may also obtain, from a third-party application service provider, application performance data associated with the application session, such as one or more application performance metrics indicative of the performance of an application session (e.g., latency, bandwidth, audio in/out, video in/out, screen share in/out, packet loss, bit rate, resolution, frames per second, feedback from users, etc.). Based on the network data and the application performance data, the NMS may generate features for a predictive model to train the predictive model and/or to predict, based on a trained predictive model, one or more application performance metrics of an application session if the application session were to be implemented. The predicted application performance metrics may be used to identify a root cause or contributor to a predicted issue of the application session.

In some examples, a given site may not have application data and such application data is unavailable for generating one or more requisite features for the predictive model. For example, the given site may not have implemented an application session (or has stopped a previous implementation of the application session), or data associated with an application session may not be readily available from the third-party application service provider when predicting one or more application performance metrics of an application session. In this example, application data, such as CPU usage of a client device during an application session, information associated with a VPN session operating concurrently with an application session, etc., are unavailable and such application data is unavailable for generating one or more requisite features for the predictive model. Without providing such features to the predictive model, the predictive model is typically unable to determine (or unable to accurately determine) one or more application performance metrics of an application session for the site without application data.

In accordance with the disclosed techniques, the NMS is configured to predict one or more application performance metrics of an application session for a site that does not have application data. For example, the NMS may estimate a value for one or more features of a site that does not have application data based on, for example, data from one or more sites that have application data (referred to herein as “out-of-site” prediction).

In some examples, a site at a given time may not have application data for generating one or more requisite features for the predictive model. In these examples, the NMS may estimate a value for the one or more features of the site without application data for a given time based on historical data associated with a prior application session implemented at a prior time (referred to herein as “out-of-time” prediction).

In some examples, the NMS may specify predefined values for one or more features of a site without application data to be used to predict application performance metrics of an application session for the site. For example, the NMS may specify predefined values that are indicative of a presumed performance of an application session (e.g., values indicative of an application session operating at optimal and/or normal conditions).

The NMS may then determine one or more application performance metrics of an application session for the site without application data based on the estimated or predefined values for the one or more features. For example, the NMS may input the estimated or predefined values for the one or more features to the predictive model, which in turn determines one or more application performance metrics of an application session for the site without application data.

The disclosed techniques may provide one or more technical advantages and practical applications. For example, by leveraging application data from one or more sites that have application data, the NMS may estimate a value for one or more missing features of a site without application data and provide the estimated values for the missing features to a prediction engine to predict one or more application performance metrics of an application session for the site. Moreover, by leveraging a predictive model to predict one or more application performance metrics for a site without application data, the computing system may predict application performance issues or failures in real-time or near real-time, or predict future application performance issues or failures, or predict if a network of the site can provide adequate services for the application, and may proactively invoke an action prior to the implementation of the application session to avoid or proactively mitigate the impact of the issues or failures experienced by a user of the application session, such as generating a notification indicating predicted issues with the performance of the application or network and/or providing recommendations to configure the network to be “application-ready.” Additionally, by leveraging application data from one or more sites that have application data or historical application data, the NMS may utilize fewer computing resources to estimate values for one or more missing features of a site without application data by not requiring the predictive model to be retrained each time the performance of an application session is determined.

The details of one or more examples of the techniques of this disclosure are set forth in the accompanying drawings and the description below. Other features, objects, and advantages of the techniques will be apparent from the description and drawings, and from the claims.

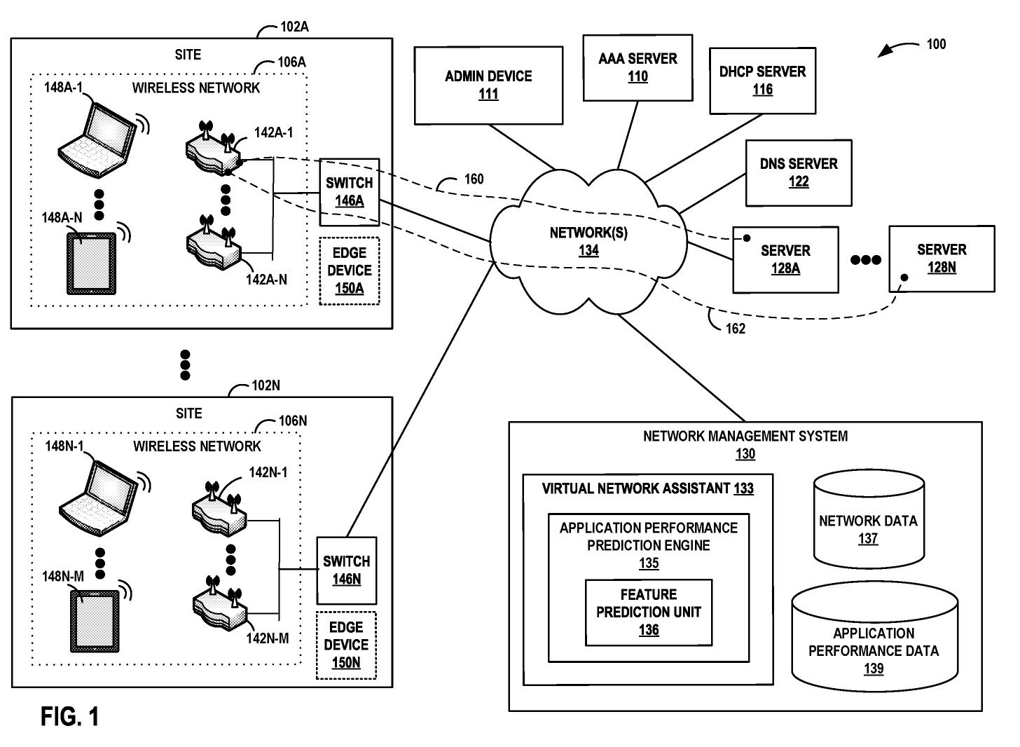

FIG. 1 is a block diagram of an example network system 100 in which a network management system (NMS) 130 is configured to predict one or more application performance metrics of an application session for a site without application data, in accordance with one or more techniques of this disclosure. Example network system 100 includes a plurality sites 102a–102n at which a network service provider manages one or more wireless networks 106s–106n, respectively. Although in FIG. 1 each site 102a–102n is shown as including a single wireless network 106a–106n, respectively, in some examples, each site 102a–102n may include multiple wireless networks, and the disclosure is not limited in this respect.

Each site 102a–102n includes a plurality of network devices, such as access points (APs) 142, switches 146, or routers (not shown) within the wired network edge. For example, site 102a includes a plurality of APs 142a-1 through 142a-n. Similarly, site 102n includes a plurality of APs 142n-1 through 142n-m. Each AP 142 may be any type of wireless access point, including, but not limited to, a commercial or enterprise AP, a router, or any other device that is connected to the wired network and is capable of providing wireless network access to client devices within the site. References to “N” or “M” may represent any number. References to “N” for different elements need not be the same number. Similarly, references to “M” for different elements need not be the same number.

Each site 102a–102n also includes a plurality of client devices, otherwise known as user equipment devices (UEs), referred to generally as UEs or client devices 148, representing various wireless-enabled devices within each site. For example, a plurality of UEs 148a-1 through 148a-n are currently located at site 102a. Similarly, a plurality of UEs 148n-1 through 148n-m are currently located at site 102n. Each UE 148 may be any type of wireless client device, including, but not limited to, a mobile device such as a smart phone, tablet or laptop computer, a personal digital assistant (PDA), a wireless terminal, a smart watch, smart ring, or other wearable device. UEs 148 may also include wired client-side devices, e.g., IoT devices such as printers, security devices, environmental sensors, or any other device connected to the wired network and configured to communicate over one or more wireless networks 106.

In order to provide wireless network services to UEs 148 and/or communicate over the wireless networks 106, APs 142 and the other wired client-side devices at sites 102 are connected, either directly or indirectly, to one or more network devices (e.g., switches, routers, or the like) via physical cables, e.g., Ethernet cables. In the example of FIG. 1, site 102a includes a switch 146a to which each of APs 142a-1 through 142a-n at site 102a are connected. Similarly, site 102n includes a switch 146n to which each of APs 142n-1 through 142n-m at site 102n are connected. Although illustrated in FIG. 1 as if each site 102 includes a single switch 146 and all APs 142 of the given site 102 are connected to the single switch 146, in other examples, each site 102 may include more or fewer switches and/or routers. In some examples, the APs and the other wired client-side devices of the given site may be connected to two or more switches and/or routers. In some examples, two or more switches at a site may be connected to each other and/or connected to two or more routers, e.g., via a mesh or partial mesh topology in a hub-and-spoke architecture. In some examples, interconnected switches and routers comprise wired local area networks (LANs) at sites 102 hosting wireless networks 106.

Example network system 100 also includes various networking components for providing networking services within the wired network including, as examples, an Authentication, Authorization and Accounting (AAA) server 110 for authenticating users and/or UEs 148, a Dynamic Host Configuration Protocol (DHCP) server 116 for dynamically assigning network addresses (e.g., IP addresses) to UEs 148 upon authentication, a Domain Name System (DNS) server 122 for resolving domain names into network addresses, a plurality of servers 128a–128n (collectively “servers 128”) (e.g., web servers, databases servers, file servers, application servers, and the like), and a network management system (NMS) 130. As shown in FIG. 1, the various devices and systems of network 100 are coupled together via one or more network(s) 134, e.g., the Internet and/or an enterprise intranet.

In the example of FIG. 1, NMS 130 is a cloud-based computing platform that manages wireless networks 106a–106n at one or more of sites 102a–102n. As further described herein, NMS 130 provides an integrated suite of management tools and implements various techniques of this disclosure. In general, NMS 130 may provide a cloud-based platform for wireless and/or wired network data acquisition, monitoring, activity logging, reporting, predictive analytics, network anomaly identification, and alert generation. In some examples, NMS 130 may be provided as-a-service (aaS), in that NMS 130 may be offered as part of an ongoing, subscription-based service to provide network management, analysis, and failure remediation tools to a customer operating one or more sites 102 over a network, such as network(s) 134. In some examples, NMS 130 outputs notifications, such as alerts, alarms, graphical indicators on dashboards, log messages, text / short messaging service (SMS) messages, email messages, and the like, and/or recommendations regarding wireless network issues to a site or network administrator (“admin”) interacting with and/or operating admin device 111. Additionally, in some examples, NMS 130 operates in response to configuration input received from the administrator interacting with and/or operating admin device 111.

Admin device 111 may comprise a computing device associated with one or more of sites 102 and/or switches 146 at the wired network edge. Admin device 111 may be implemented as any suitable device for presenting output and/or accepting user input. For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 134 or other means of communication.

In some examples, one or more of the network devices, e.g., APs 142, switches 146, or routers, may connect to corresponding edge devices 150a–150n via physical cables, e.g., Ethernet cables. Edge devices 150 comprise cloud-managed, wireless local area network (LAN) controllers. Each of edge devices 150 may comprise an on-premises device at a site 102 that is in communication with NMS 130 to extend certain microservices from NMS 130 to the on-premises network devices while using NMS 130 and its distributed software architecture for scalable and resilient operations, management, troubleshooting, and analytics.

Each one of the network devices of network system 100, e.g., servers 110, 116, 122 and/or 128, APs 142, UEs 148, switches 146, and any other servers or devices attached to or forming part of network system 100, may include a system log or an error log unit wherein each one of these network devices records the status of the network device including normal operational status and error conditions. Throughout this disclosure, one or more of the network devices of network system 100, e.g., servers 110, 116, 122 and/or 128, APs 142, UEs 148, and switches 146, may be considered “third-party” network devices when owned by and/or associated with a different entity than NMS 130 such that NMS 130 does not receive, collect, or otherwise have access to the recorded status and other data of the third-party network devices. In some examples, edge devices 150 may provide a proxy through which the recorded status and other data of the third-party network devices may be reported to NMS 130.

In some examples, NMS 130 monitors network data 137 received from wireless networks 106a–106n at each site 102a–102n, respectively, and manages network resources, such as APs 142 at each site, to deliver a high-quality wireless experience to end users, IoT devices and clients at the site. For example, NMS 130 may include a virtual network assistant (VNA) 133 that implements an event processing platform for providing real-time insights and simplified troubleshooting for IT operations, and that automatically takes corrective action or provides recommendations to proactively address wired or wireless network issues. VNA 133 may, for example, include an event processing platform configured to process hundreds or thousands of concurrent streams of network data 137 from sensors and/or agents associated with APs 142 and/or nodes within network 134. For example, VNA 133 of NMS 130 may include an underlying analytics and network error identification engine and alerting system in accordance with various examples described herein. The underlying analytics engine of VNA 133 may apply historical data and models to the inbound event streams to compute assertions, such as identified anomalies or predicted occurrences of events constituting network error conditions. As further described below, VNA 133 may also predict one or more application performance metrics of an application session for a site without application data, in accordance with one or more techniques of the disclosure. Further, VNA 133 may provide real-time alerting and reporting to notify a site or network administrator via admin device 111 of any predicted events, anomalies, trends, and may perform root cause analysis and automated or assisted error remediation. In some examples, VNA 133 of NMS 130 may apply machine learning techniques to identify the root cause or contributor of error conditions detected or predicted from the streams of network data 137. If the root cause or contributor may be automatically resolved, VNA 133 may invoke one or more corrective actions to correct the root cause or contributor of the error condition, thus automatically improving the underlying SLE metrics and also automatically improving the user experience.

In operation, NMS 130 observes, collects, and/or receives network data 137, which may take the form of data extracted from messages, counters, and statistics, for example. The network data may include a plurality of states or parameters indicative of one or more aspects of wireless network performance, such as service level expectation/experience (SLE) metrics (e.g., RSSI, jitter, transmission bytes, radio utilization, total number of clients per AP, number of APs per site), events, etc. In some examples, network data 137 may include information associated with one or more virtual private network (VPN) sessions. Information associated with a VPN session may include, for example, a location of a client device and a location of a VPN server of the VPN session, and/or a distance between the client device and the VPN server.

In accordance with one specific implementation, a computing device is part of NMS 130. In accordance with other implementations, NMS 130 may comprise one or more computing devices, dedicated servers, virtual machines, containers, services, or other forms of environments for performing the techniques described herein. Similarly, computational resources and components implementing VNA 133 may be part of the NMS 130, may execute on other servers or execution environments, or may be distributed to nodes within network 134 (e.g., routers, switches, controllers, gateways, and the like).

One or more of servers 128 may include application servers that provide cloud-based applications. The cloud-based applications may include, for example, video conferencing applications, gaming applications, or other applications. In some examples, one or more sites may implement an application session, such as application session 160. For example, in a client-to-cloud application session topology of application session 160, client device 148a-1 may interface with AP 142a-1 that provides client device 148a-1 with access to wireless network 106a, which in turn may be in communication with a wired network provided by AP 142a-1 and switch 146a. The wired network may be in communication with a WAN that may interface with a service provider network provided by an Internet service provider (ISP), such as network 134, which in turn provides connectivity to a third-party application server, e.g., server 128a, which hosts an application accessible by client device 148a-1.

In some examples, NMS 130 may obtain data associated with application session 160 and provide the data as features to a predictive model (e.g., a machine learning (ML) model) to determine a root cause of an issue to application session 160 and/or to predict one or more application performance metrics of an application session that may be implemented by site 102a. For example, NMS 130 may obtain network data of network devices (e.g., AP 142a-1, switch 146a, etc.) and/or client devices 148 associated with application session 160, such as signal strength (RSSI), jitter, transmission bytes, radio utilization, total number of clients per AP, number of APs per site, information associated with one or more implemented VPN sessions (e.g., VPN session 162), CPU usage data of a client device, etc., observed during application session 160. NMS 130 may also obtain, from application server 128a, application performance data associated with application session 160, such as latency, bandwidth, audio in/out, video in/out, screen share in/out, packet loss, bit rate, resolution, frames per second, feedback from users, etc. Based on the network data and the application performance data associated with application session 160, NMS 130 may generate features for a predictive model to train the predictive model and/or to determine, based on a trained predictive model, one or more features causing or contributing to an issue of application session 160 that has already occurred and/or predict one or more application performance metrics of an application session if the application were to be implemented by devices at site 102a.

In some examples, data associated with an application session may be unavailable for a given site, such as site 102n, that has not implemented an application session (or has stopped a previous implementation of an application session), or data associated with an application session may not be readily available from the third-party application service provider when predicting one or more application performance metrics of an application session. Because an application session has not been implemented by devices of site 102n, application data, such as CPU usage data of a client device during an application session implemented by devices at site 102n and/or information associated with a VPN session operating concurrently with an application session implemented by devices at site 102n, may be unavailable and such application data is unable to be used to generate the requisite features for the predictive model. Without providing such application data for generating features for the predictive model, the predictive model is typically unable to determine (or unable to accurately determine) the one or more application performance metrics of an application session if the application session were to be implemented by devices of site 102n.

In accordance with one or more techniques of this disclosure, NMS 130 may include application performance prediction engine 135 that is configured to predict one or more application performance metrics of an application session for a site without application data, in accordance with one or more techniques of this disclosure.

In the example of FIG. 1, feature prediction unit 136 of application performance prediction engine 135 may estimate a value for one or more features (e.g., CPU usage data during an application session, VPN distance from client device to VPN server for a VPN session operating concurrently with an application session, etc.) of a site without application data, such as site 102n. In some examples, feature prediction unit 136 may estimate a value for the one or more features of site 102n based on data of a site with application data, such as site 102a.

In the example of FIG. 1, application data of site 102a may include data associated with application session 160, such as CPU usage data of client device 148a-1 during application session 160, VPN distance for VPN session 162 operating currently with application session 160, and/or other data associated with application session 160. In this example, feature prediction unit 136 may apply one or more predictive models (e.g., regression model, classification model, etc.) to estimate values for features of site 102n, such as CPU usage data, VPN distance of a VPN session, etc.

In some examples, feature prediction unit 136 may estimate a value for a feature of site 102n based on historical data associated with a prior application session, such as data associated with one or more previously implemented application sessions. For example, site 102n may implement an application session (not shown in FIG. 1), but may not have received data associated with the application session from the third-party application service provider. In this example, feature prediction unit 136 may estimate a value for the one or more features of site 102n based on historical application data associated with a prior application session implemented by devices of site 102a and/or historical data associated with a prior application session implemented by devices of site 102n.

In some examples, feature prediction unit 136 may specify a predefined value for a feature of site 102n, where the predefined value is indicative of a presumed performance of an application session. In some examples, feature prediction unit 136 may specify a predefined value indicative of a presumed performance of an application session operating under optimal conditions (e.g., under 10% CPU utilization by a client device during an application session, 0 VPN distance for a VPN session operating concurrently with an application session, etc.). In some examples, feature prediction unit 136 may specify a predefined value for a feature of site 102n, where the predefined value is indicative of a presumed performance of an application session operating under normal or typical conditions (e.g., under 50% CPU utilization by a client device during an application session, a predefined VPN distance for a VPN session operating concurrently, etc.). The predefined values for one or more features of site 102n may be referred to herein as “golden values.”

Application performance prediction engine 135 may then predict one or more application performance metrics of an application session for site 102n based on the estimated value for the one or more features of site 102n. For example, application performance prediction engine 135 may provide the estimated or predefined values for the features and one or more other features (e.g., features corresponding to network data unassociated with an application session and obtained from site 102n) to a machine learning model, which in turn predicts one or more application performance metrics of an application session if the application session were to be implemented by devices of site 102n. The predictive model may be trained based on network data and application performance data of one or more sites with application data obtained over a first period of time.

Based on the predicted one or more application performance metrics of the application session if the application session were to be implemented by devices of site 102n, application performance prediction engine 135 may determine a predicted issue with the application session for the second site. In some examples, application performance prediction engine 135 may, in response to determining the predicted issue with the application session for the second site, perform an action prior to implementing the application session by devices of site 102n to proactively remedy the predicted issue with the application session.

The examples above are just some examples of application performance metrics that can be predicted by the predictive model. The predictive model may be trained to predict any application performance metric based on the performance of any feature and/or combination of features.

Although the techniques of the present disclosure are described in this example as performed by NMS 130, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NMS 130, or may be distributed throughout network 100, and may or may not form a part of NMS 130.

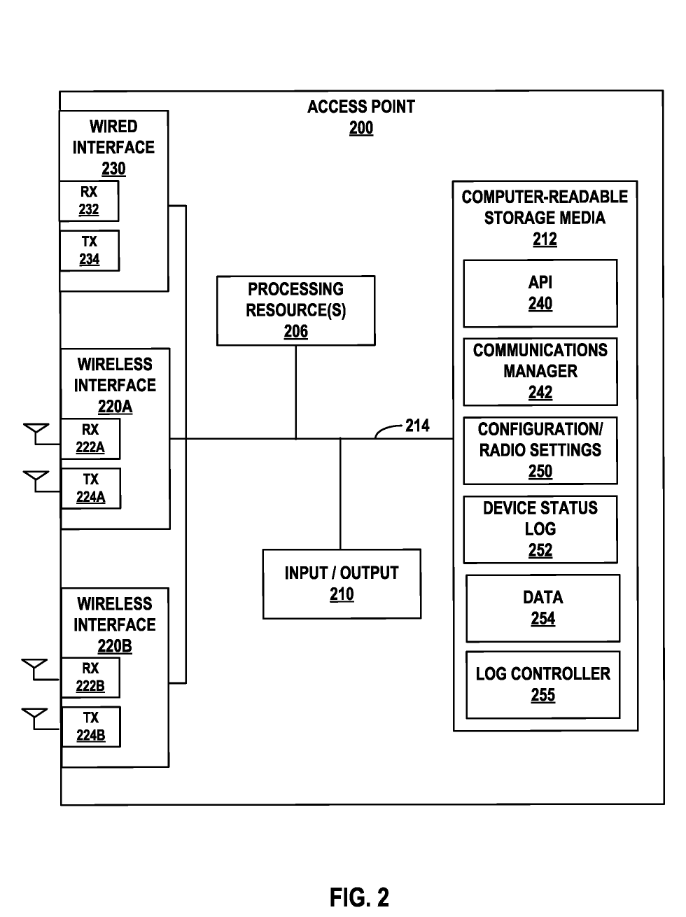

FIG. 2 is a block diagram of an example access point (AP) device 200 configured in accordance with one or more techniques of this disclosure. The example access point 200 shown in FIG. 2 may be used to implement any of APs 142 as shown and described herein with respect to FIG. 1. Access point 200 may comprise, for example, a Wi-Fi, Bluetooth and/or Bluetooth Low Energy (BLE) base station or any other type of wireless access point.

In the example of FIG. 2, access point 200 includes a wired interface 230, wireless interfaces 220A–220B one or more processing resources 206, one or more computer-readable storage media 212, and input/output 210, coupled together via a bus 214 over which the various elements may exchange data and information. Wired interface 230 represents a physical network interface and includes a receiver 232 and a transmitter 234 for sending and receiving network communications, e.g., packets. Wired interface 230 couples, either directly or indirectly, access point 200 to a wired network device, such as a switch or router, within the wired network via a cable, such as an Ethernet cable.

First and second wireless interfaces 220a and 220b represent wireless network interfaces and include receivers 222a and 222b, respectively, each including a receive antenna via which access point 200 may receive wireless signals from wireless communications devices, such as user equipment devices. First and second wireless interfaces 220a and 220b further include transmitters 224a and 224b, respectively, each including transmit antennas via which access point 200 may transmit wireless signals to the wireless communications devices. In some examples, first wireless interface 220a may include a Wi-Fi 802.11 interface (e.g., 2.4 GHz and/or 5 GHz) and second wireless interface 220b may include a Bluetooth interface and/or a Bluetooth Low Energy (BLE) interface. In additional examples, access point 200 may include an ultrawideband (UWB) chipset (not shown) having a transmitter and/or antennas used for shortrange wireless communication in accordance with UWB communication protocols.

Processing resource(s) 206 are programmable hardware-based processors configured to execute software instructions, such as those used to define a software or computer program, stored to a computer-readable storage medium 212, such as non-transitory computer-readable media including a storage device (e.g., a disk drive, or an optical drive) or a memory (such as Flash memory or RAM) or any other type of volatile or non-volatile memory, that stores instructions to cause the one or more processing resources 206 to perform the techniques described herein.

Computer-readable storage media 212 includes one or more devices configured to store programming units and/or data associated with operation of access point 200. For example, computer-readable storage media 212 may include non-transitory computer-readable media including a storage device (e.g., a disk drive, or an optical drive) or a memory (such as Flash memory or RAM) or any other type of volatile or non-volatile memory, that stores instructions to cause the one or more processing resources 206 to perform the techniques described herein.

In this example, computer-readable storage media 212 stores executable software including an application programming interface (API) 240, a communications manager 242, configuration/radio settings 250, a device status log 252, data 254, and log controller 255. Device status log 252 includes a list of events specific to access point 200. The events may include a log of both normal events and error events such as, for example, memory status, reboot or restart events, crash events, cloud disconnect with self-recovery events, low link speed or link speed flapping events, Ethernet port status, Ethernet interface packet errors, upgrade failure events, firmware upgrade events, configuration changes, etc., as well as a time and date stamp for each event. Log controller 255 determines a logging level for the device based on instructions from a network management system (e.g., NMS 130 of FIG. 1). Data 254 may store any data used and/or generated by access point 200, including data collected from user equipment devices, such as data used to calculate one or more SLE metrics, that is transmitted by access point 200 for cloud-based management of wireless networks by the network management system.

Input/output (I/O) 210 represents physical hardware components that enable interaction with a user, such as buttons, a display, and the like. Although not shown, computer-readable storage media 212 typically stores executable software for controlling a user interface with respect to input received via I/O 210. Communications manager 242 includes program code that, when executed by processing resource(s) 206, cause access point 200 to communicate with UEs 148 and/or network(s) 134 via any of interface(s) 230 and/or 220a–220b. Configuration settings 250 include any device settings for access point 200 such as radio settings for each of wireless interface(s) 220a–220b. These settings may be configured manually or may be remotely monitored and managed by NMS 130 to optimize wireless network performance on a periodic (e.g., hourly or daily) basis.

As described herein, AP device 200 may measure and report network data from device status log 252 to the network management system. The network data may comprise event data, telemetry data, and/or other SLE-related data. The network data may include various parameters indicative of the performance and/or status of the wireless network. The parameters may be measured and/or determined by one or more of the UE devices and/or by one or more of the APs in a wireless network. In some examples, AP device 200 may measure and report network data associated with an application session to the network management system. For example, AP device 200 may exchange data for a cloud-based application during an application session (e.g., application session 160 of FIG. 1) and may measure and report network data from status log 252 that was measured during the application session. For instance, AP device 200 may measure network data such as signal strength (RSSI), jitter, transmission bytes, radio utilization, total number of clients per AP, number of APs per site during the application session, and send the network data associated with the application session to the network management system.

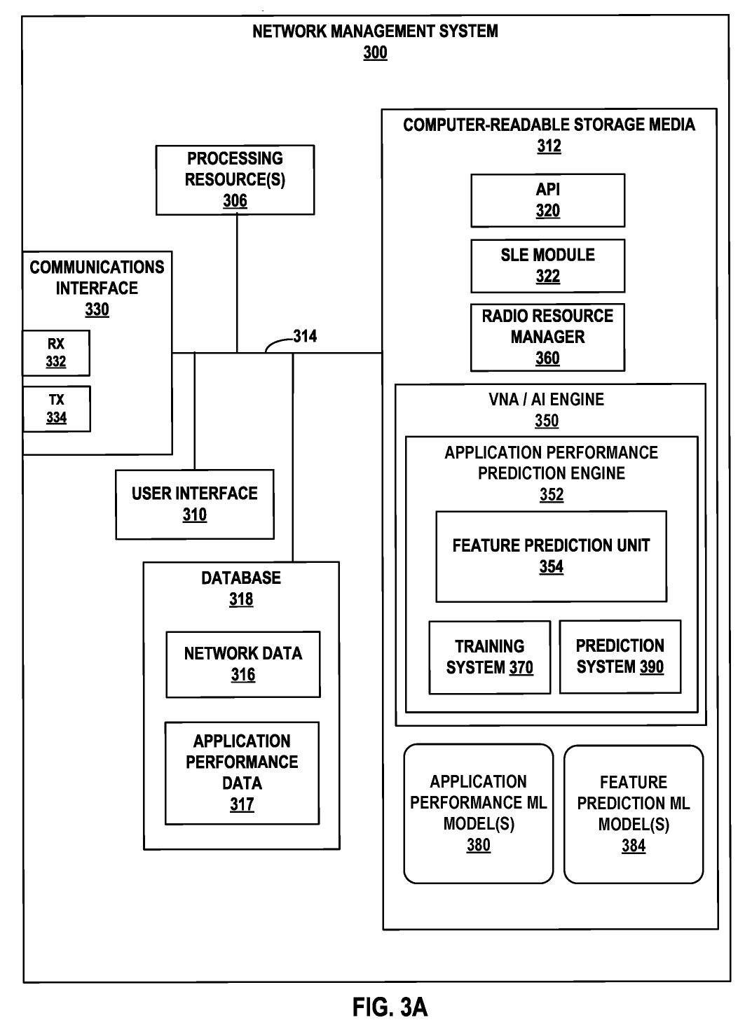

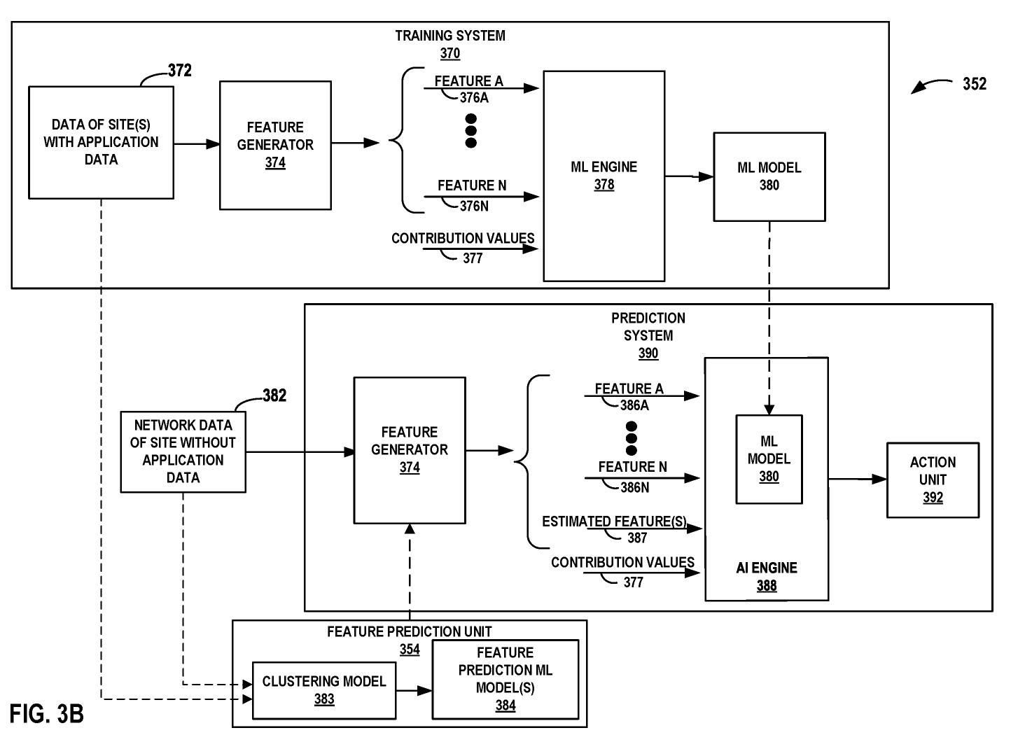

FIG. 3A is a block diagram of an example network management system (NMS) 300 configured to predict one or more application performance metrics of an application session for a site without application data, in accordance with one or more techniques of the disclosure. NMS 300 may be an example implementation of NMS 130 in FIG. 1.

NMS 300 includes a communications interface 330, processing resource(s) 306, a user interface 310, computer-readable storage media 312, and a database 318. The various elements are coupled together via a bus 314 over which the various elements may exchange data and information. In some examples, NMS 300 receives data from one or more of client devices, APs, switches, and other network nodes within a network, which may be used to calculate one or more SLE metrics and/or update network data 316 in database 318. NMS 300 analyzes this data for cloud-based management of wireless and/or wired networks, such as determining a root cause of an issue to an application session and/or predicting one or more application performance metrics of an application session. The received data is stored as network data 316 in database 318.

Processing resource(s) 306 execute software instructions, such as those used to define a software or computer program, stored to computer-readable storage media 312, such as non-transitory computer-readable media including a storage device (e.g., a disk drive, or an optical drive) or a memory (such as Flash memory or RAM) or any other type of volatile or non-volatile memory, that stores instructions to cause the one or more processors 306 to perform the techniques described herein.

Communications interface 330 may include, for example, an Ethernet interface. Communications interface 330 couples NMS 300 to a network and/or the Internet, and/or any local area networks. Communications interface 330 includes a receiver 332 and a transmitter 334 by which NMS 300 receives/transmits data and information to/from any of client devices, APs, switches, servers, and/or any other network nodes, devices, or systems of a network system.

The data and information received by NMS 300 may include, for example, telemetry data, SLE-related data, or event data received from one or more of client devices, APs, switches, or other network nodes used by NMS 300 to remotely monitor the performance of wireless and/or wired networks and application sessions from client device to cloud-based application server. NMS 300 may further transmit data via communications interface 330 to any of network devices such as client devices, APs, switches, or other network nodes within the network, to remotely manage wireless networks and portions of the wired network.

Computer-readable storage media 312 includes one or more devices configured to store programming units and/or data associated with operation of NMS 300. For example, computer-readable storage media 312 may include non-transitory computer-readable media including a storage device (e.g., a disk drive, or an optical drive) or a memory (such as Flash memory or RAM) or any other type of volatile or non-volatile memory, that stores instructions to cause the processing resource(s) 306 to perform the techniques described herein.

In this example, computer-readable storage media 312 includes an API 320, an SLE module 322, a virtual network assistant (VNA)/AI engine 350, and a radio resource manager (RRM) 360. SLE module 322 enables set up and tracking of thresholds for SLE metrics for each wireless and/or wired network. SLE module 322 further analyzes SLE-related data collected by devices in each wireless and/or wired network. For example, APs collect SLE-related data from UEs currently connected to a wireless network. In some examples, switches collect SLE-related data from devices connected to a wired network. This data is transmitted to NMS 300, which executes SLE module 322 to determine one or more SLE metrics for each device or wireless and/or wired network. This data, in addition to any network data collected by devices in the wireless and/or wired network, is transmitted to NMS 300 and stored as, for example, network data 316 in database 318.

RRM engine 360 monitors one or more metrics for each site in order to learn and optimize the RF environment at each site. For example, RRM engine 360 may monitor the coverage and capacity SLE metrics for a wireless network at a site in order to identify potential issues with SLE coverage and/or capacity in the wireless network and to make adjustments to the radio settings of the access points at each site to address the identified issues. For example, RRM engine 360 may determine channel and transmit power distribution across all APs in each wireless network. For example, RRM engine 360 may monitor events, power, channel, bandwidth, and number of clients connected to each AP. RRM engine 360 may further automatically change or update configurations of one or more APs at a site with an aim to improve the coverage and capacity SLE metrics and thus to provide an improved wireless experience for the user.

VNA/AI engine 350 analyzes data received from network devices as well as its own data to identify when undesired to abnormal states are encountered at one of the network devices. For example, VNA/AI engine 350 may identify the root cause of any undesired or abnormal states, e.g., any poor SLE metric(s) indicative of issues at one or more network devices. In addition, VNA/AI engine 350 may automatically invoke one or more corrective actions intended to address the identified root cause(s) of one or more poor SLE metrics. Examples of corrective actions that may be automatically invoked by VNA/AI engine 350 may include, but are not limited to, invoking RRM 360 to reboot one or more APs, adjusting/modifying the transmit power of a specific radio in a specific AP, adding SSID configuration to a specific AP, changing channels on an AP or a set of APs, etc. The corrective actions may further include restarting a switch and/or a router, invoking downloading of new software to an AP, switch, or router, etc. These corrective actions are given for example purposes only, and the disclosure is not limited in this respect. If automatic corrective actions are not available or do not adequately resolve the root cause, VNA/AI engine 350 may proactively provide a notification including recommended corrective actions to be taken by IT personnel, e.g., a site or network administrator using an admin device, to address the network error.

In accordance with the disclosed techniques, VNA/AI engine 350 includes application performance prediction engine 352 that may determine one or more application performance metrics of an application session for a site without application data.

In this example, application performance prediction engine 352 includes a feature prediction unit 354 to estimate a value of each of one or more features (e.g., CPU usage data, VPN distance, etc.) of a site without application data (e.g., site 102N of FIG. 1). For example, feature prediction unit 354 may apply a clustering model of one or more feature prediction ML models 384 to network data 316 and application performance data 317 of a plurality of sites to determine a set of one or more sites with which feature prediction unit 354 may leverage the application data to estimate a value for a feature of a site without application data. Feature prediction ML model(s) 384 may include one or more clustering models, such as a centroid-based clustering model, a density-based clustering model, a distribution-based clustering model, a hierarchical clustering model, or other clustering models, that may cluster data of sites based on similarities to network data 316 of the sites and/or similarities to application performance data 317 of the sites. In this example, the clustering model may output a cluster that includes data of a site without application data (e.g., site 102n of FIG. 1) and data of a set of one or more sites with application data (e.g., site 102a of FIG. 1).

Based on determining that data of a set of one or more sites with application data and data of a site without application data belong to the same cluster, feature prediction unit 354 may estimate a value for one or more features of the site without application data based on application data of the site with application data. As further described below in FIG. 3B, feature prediction unit 354 may apply one or more feature prediction models 384 (e.g., regression model, classification model, etc.) to estimate values for features of the site without application data (e.g., CPU usage of a client device during an application session and/or information associated with a VPN session operating concurrently with an application session, etc.).

In some examples, feature prediction unit 354 may determine a value for a feature of a site without application data based on historical data associated with a prior application session, such as data associated with one or more previously implemented application sessions. For example, a site may implement an application session, but may not have received data associated with the application session from the third-party application service provider. In this example, feature prediction unit 354 may estimate a value for the one or more features of the site based on historical application data associated with a prior application session implemented by devices of the site and/or historical data associated with a prior application session implemented by devices of another site. In some examples, feature prediction unit 354 may estimate a value of the one or more features of the site based on data averages of the site.

In some examples, feature prediction unit 354 may specify a predefined value for a feature of a site without application data, where the predefined value is indicative of a presumed performance of an application session. In some examples, feature prediction unit 354 may specify a predefined value indicative of a presumed performance of an application session operating under optimal conditions (e.g., under 10% CPU utilization by a client device during an application session, 0 VPN distance for a VPN session operating concurrently with an application session, etc.). In some examples, feature prediction unit 354 may specify a predefined value for a feature of the site without application data, where the predefined value is indicative of a presumed performance of an application session operating under normal or typical conditions (e.g., under 50% CPU utilization by a client device during an application session, a predefined VPN distance for a VPN session operating concurrently, etc.).

Application performance prediction engine 352 may then predict one or more application performance metrics of an application session for the site without application data based on the estimated and/or predefined values of the one or more features of the site. For example, application performance prediction engine 352 may provide the estimated and/or predefined values for the features and one or more other features (e.g., features corresponding to network data unassociated with an application session and obtained from the site without application data) to application performance ML model(s) 380, which in turn determines one or more application performance metrics of an application session that may be implemented by devices of the site without application data.

The application performance ML model(s) 380 may be trained based on network data and application performance data of one or more sites with application data obtained over a first period of time. In this example, application performance prediction engine 352 may include training system 370 configured to train application performance ML model(s) 380 and a prediction system 390 configured to utilize the application performance ML model(s) 380 to predict one or more application performance metrics of an application session. As further described in FIG. 3B, training system 370 may obtain historical network data 316 (obtained at a first period of time) from network devices of a site that implemented an application session and application performance data 317 from a third-party application service provider associated with the application session (e.g., application data associated with application session 160 of site 102a of FIG. 1) to train application performance ML model(s) 380 to predict one or more application performance metrics for an application session for a site without application data. As further described in FIG. 3B, prediction system 390 may obtain current network data 316 (e.g., obtained at a second, subsequent period of time) of the site without application data (e.g., network data of devices of site 102n of FIG. 1) and apply the current network data 316 of the site and the estimated value of the one or more features of the site as an input to application performance ML model(s) 380 to predict an application performance metric of an application session for the site without application data. The predicted application performance metric may indicate a predicted occurrence of an issue of an application session if the application session were to be implemented by devices of the site and identify one or more features that impact the application performance metrics.

The application performance ML model(s) 380 may include supervised learning models using decision trees and gradient boosting methods, neural networks, generative pretrained transformers (GPTs), or other types of predictive models including unsupervised learning models. In some examples, application performance ML model(s) 380 may incorporate Shapley Additive Explanation (SHAP), approximations of SHAP values, and/or Local Interpretable Model-Agnostic Explanations (Lime) to provide a way in which to measure the contribution of each network feature performance to the predicted issue. For example, application performance prediction engine 352 may assign a value to each network feature performance based on how much the network feature performance contributes to the predicted issue (e.g., level of contribution). These values may be computed by evaluating the predictive model’s predictions for possible subsets of the network features performance, and then taking the average difference in predictions when a particular network feature performance is added or removed from the subset. In this way, by incorporating SHAP or Lime values to the application performance ML model(s) 380, application performance prediction engine 352 may identify the network features that have the most significant effect or influence towards the predicted issue. The examples above are just some examples of application performance metrics that can be predicted by application performance ML model(s) 380. Application performance ML model(s) 380 may be trained to predict any application performance metric based on the performance of any network feature and/or combination of network features.

Feature prediction ML model(s) 384 may include a supervised ML model and/or an unsupervised ML model. For example, feature prediction ML model(s) 384 may include an unsupervised ML model, such as one or more clustering models including a centroid-based clustering model, a density-based clustering model, a distribution-based clustering model, a hierarchical clustering model, and/or other clustering models. As described above, feature prediction unit 354 may apply a clustering model of feature prediction ML model(s) 384 to network data 316 and application performance data 317 of a plurality of sites to determine a set of one or more sites with which feature prediction unit 354 may leverage the application data to estimate a value for a feature of a site without application data.

Feature prediction ML model(s) 384 may also include a supervised ML model such as one or more predictive models including a logistical regression, naïve Bayesian, support vector machine (SVM), decision trees and gradient boosting methods, neural networks, generative pretrained transformers (GPTs), and/or other types of learning models. As described above, feature prediction unit 384 may apply feature prediction ML model(s) 384 (e.g., regression model, classification model, etc.) to estimate values for features of the site without application data.

Although not shown in FIG. 3A, in some examples, database 318 may store the training data and VNA/AI engine 350 or a dedicated training module may be configured to train application performance ML model(s) 380 based on the training data to determine appropriate weights across the one or more features of the training data.

FIG. 3B illustrates an example of the training system 370 and the prediction system 390 of application performance prediction engine 352 in greater detail. Training system 370 includes ML engine 378 configured to train application performance ML model(s) 380 to predict an application performance metric (e.g., latency) that may indicate a predicted occurrence of an issue of an application session based on the performance of a feature determined from the network data. In accordance with the techniques described in this disclosure, feature prediction unit 354 may estimate a value one or more features of a site without application data and provide the estimated value to prediction system 390 to predict an application performance metric of an application session for the site without application data.

In one example, ML engine 378 uses supervised machine learning techniques using decision trees and gradient boosting methods to train the application performance ML model(s) 380 to predict an application performance metric. For example, feature generator 374 may generate features 376a–376n based on data 372 of a site with application data over a first period of time, such as network data obtained from one or more network devices associated with an application session and application performance data associated with the application session obtained from a third-party application service provider. Features 376 may provide input variables for application performance ML model(s) 380 to make predictions about a target variable (e.g., application performance metric of an application session). Features 376 may represent, for example, features that may be the most relevant to the performance of an application session. For example, a weak radio signal of a client device’s connection to an access point (e.g., RSSI below -80 dB) may be a contributing factor of an application session experiencing latency issues. Moreover, an access point that operates with a radio frequency channel that suffers from interference may additionally, or alternatively, be a contributing factor in the application session experiencing latency issues. In some examples, CPU utilization of a client device operating during an application session may be a contributing factor in the application session experiencing latency issues. In some examples, a distance between a client device and a VPN server for a VPN session operating concurrently with the application session may be a contributing factor in the application session experiencing latency issues. Other network features used to predict a latency issue may include an average RSSI of a client device, a number of client devices of a site (e.g., active and/or inactive), a download speed (mbps) of a site, a last round-trip time (RTT) of an access point, the RTT of a site), a number of APs of a site, a WiFi retry rate of a client device, interference of a radio channel, a radio channel, client device received bytes, the WiFi version, a number of client device streams, radio channel bandwidth, radio channel band, and other features indicative of the performance of the network.

Based on features 376, ML engine 378 may train application performance ML model(s) 380 to predict a target variable, e.g., an application performance metric of an application session, by learning decision rules inferred from features 376.

In some examples, ML engine 378 may incorporate contribution values 377, e.g., Shapley Additive Explanation (SHAP) or Local Interpretable Model-Agnostic Explanations (Lime) values, to provide a way in which to measure the contribution of each feature 376 to the predicted application performance issue. For example, application performance prediction engine 352 may assign a value to each feature 376 based on how much the feature contributes to the predicted issue (e.g., level of contribution). As one example, training system 370 of application performance prediction engine 352 may assign a first contribution value to feature 376a (e.g., RSSI value) that indicates feature 376a has a first level of contribution to a latency issue of an application session. Training system 370 of application performance prediction engine 352 may assign a second contribution value to feature 376b (e.g., radio utilization information) that indicates feature 376b has a second level of contribution to the latency issue of the application session. As another example, training system 370 of application performance prediction engine 352 may assign a third contribution value to feature 376c (e.g., VPN server distance information) that indicates feature 376c has a third level of contribution to the latency issue of the application session. Each of the contribution values may comprise of a different contribution value that represents a level of contribution by a corresponding feature to the latency issue (or other performance issue) of the application session. For example, the third contribution value assigned to feature 376c (e.g., VPN server distance) may be greater than the first contribution value assigned to feature 376a (e.g., RSSI value) which may indicate that feature 376c has a greater impact to the latency issue of the application session than feature 376a.

These values are computed by evaluating the application performance ML model’s predictions for possible subsets of the features, and then taking the average difference in predictions when a particular feature is added or removed from the subset. In this way, by incorporating contribution values 377 to application performance ML model(s) 380, application performance prediction engine 352 may identify the features 376 that have the most significant effect or influence towards the predicted issue.

After training, application performance ML model(s) 380 may be deployed for use by AI engine 388 of prediction system 390. Feature generator 374 of prediction system 390 may then process network data 382 of a site without application data, such as network data obtained from the one or more network devices at the site without application data into features 386a–386n. Features 386 may represent the same type of features as were used by ML engine 378, e.g., network features 376a–376n, to generate application performance ML model(s) 380 based on data 372 of site 102a, but may represent different values.

In accordance with the techniques described in this disclosure, feature prediction unit 354 may estimate a value for one or more features 387 for a site without application data. As described above, feature prediction unit 354 may apply a clustering model 383 to data 372 of one or more sites with application data (e.g., network data and application performance data of a site) and network data 382 of a site without application data to determine a set of one or more sites with which feature prediction unit 354 may leverage the application data to estimate a value for a feature of the site without application data. In this example, the clustering model 383 may output a cluster that includes data 382 of the site without application data and data 372 of a set of one or more sites with application data.

Based on determining that data of the site with application data and data of the site without application data belong to the same cluster, feature prediction unit 354 may estimate a value of one or more features 387 of the site without application data based on application data of the site with application data. In this example, feature prediction unit 354 may apply feature prediction ML model(s) 384 (e.g., regression model, classification model, etc.) to estimate values for features of the site without application data. For example, feature prediction ML model(s) 384 may include a target variable for estimating a value for CPU usage data of a client device that may be operating during an application session. In this example, feature prediction unit 354 may input network data of the site without application data (e.g., network data unassociated with an application session) and CPU usage data of the site with application data to feature prediction ML model(s) 384, and feature prediction ML model(s) 384 may output a value for estimated feature 387 specifying CPU usage data of a client device for the site without application data. In another example, feature prediction ML model(s) 384 may include a target variable for estimating a value for VPN distance of a VPN session that may be operating concurrently to an application session for the site without application data. In this example, feature prediction unit 354 may input network data of the site without application data (e.g., network data unassociated with an application session) and VPN information of the site with application data to feature prediction ML model(s) 384, and feature prediction ML model(s) 384 may output a value for estimated feature 387 specifying VPN distance of a VPN session for the site without application data. Feature prediction ML model(s) 384 may be trained based on data of a site with application data (e.g., data of the site with application data).

In some examples, feature prediction unit 354 may specify a value for a feature of a site without application data based on historical data associated with a prior application session, such as data associated with one or more previously implemented application sessions. For example, feature prediction unit 354 may estimate a value of the one or more features of the site without application data based on historical application data associated with a prior application session implemented by devices of the site with application data and/or historical data associated with a prior application session implemented by devices of the site without application data.

In some examples, feature prediction unit 354 may specify a predefined value for a feature of a site without application data, where the predefined value is indicative of a presumed performance of an application session. In some examples, feature prediction unit 354 may specify a predefined value indicative of a presumed performance of an application session operating under optimal conditions (e.g., under 10% CPU utilization by a client device during an application session, 0 VPN distance for a VPN session operating concurrently with an application session, etc.) or a predefined value indicative of a presumed performance of an application session operating under normal or typical conditions (e.g., under 50% CPU utilization by a client device during an application session, a predefined VPN distance for a VPN session operating concurrently, etc.).

AI engine 388 applies features 386 and one or more estimated features 387 (and in some examples, contribution values 377) to application prediction ML model(s) 380 as input. For instance, feature 386a may include an RSSI value indicating the signal strength of a user equipment device connected to an access point within the site without application data, estimated feature 387 may include an estimated value of CPU usage of the user equipment device during an application session, and so on, and each of the features 386 and estimated feature(s) 387 are input into application performance ML model(s) 380, which may output a prediction of one or more application performance metrics (e.g., latency) of an application session if the application session were to be implemented by the site without application data.

If the one or more predicted application performance metrics indicate an issue with an application session, action unit 392 may invoke an action prior to the implementation of the application session by the site without application data, such as generating a notification to an administrator device that identifies the root cause or contributor to the issue of the application session or a remedial action for the issue, or automatically reconfiguring one or more components of network devices to correct the issue, such as to instruct RRM engine 360 to automatically change or update configurations of one or more network devices associated with the application session.

Although the techniques of the present disclosure are described in this example as performed by the network management system, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than the network management system, or may be distributed throughout a network, and may or may not form a part of the network management system.

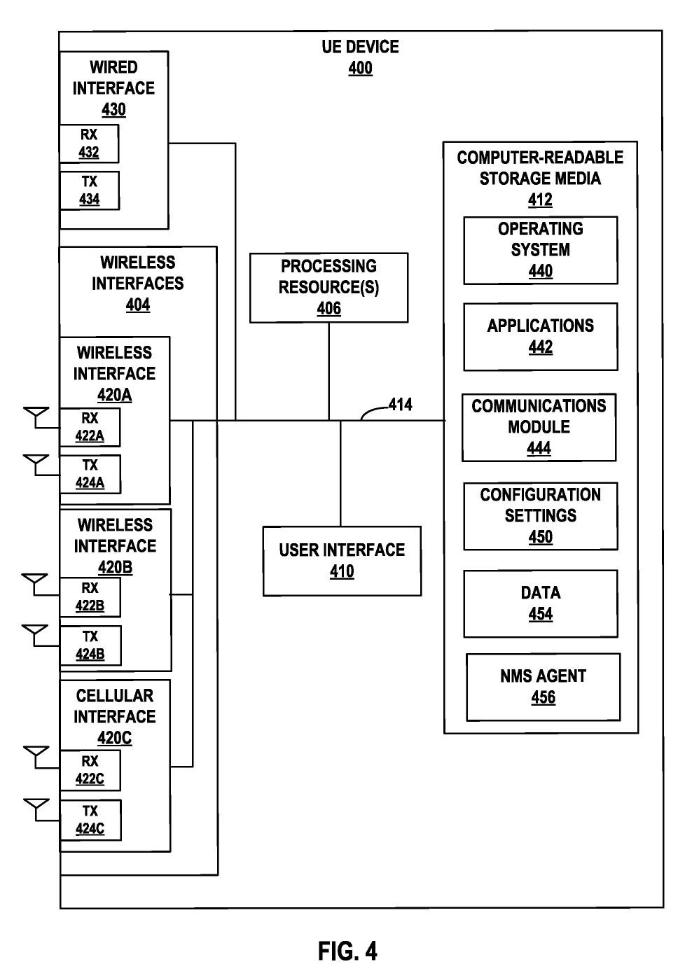

FIG. 4 shows an example user equipment (UE) device 400. Example UE device 400 shown in FIG. 4 may be an example implementation of any of UEs 148, as shown and described herein with respect to FIG. 1. UE device 400 may include any type of wireless client device, and the disclosure is not limited in this respect. For example, UE device 400 may include a mobile device such as a smart phone, tablet or laptop computer, a personal digital assistant (PDA), a wireless terminal, a smart watch, a smart ring, or any other type of mobile or wearable device. In accordance with techniques described in this disclosure, UE 400 may also include a wired client-side device, e.g., an IoT device such as a printer, a security sensor or device, an environmental sensor, or any other device connected to the wired network and configured to communicate over one or more wireless networks.

UE device 400 includes a wired interface 430, wireless interfaces 420a–420c, processing resource(s) 406, computer-readable storage media 412, and a user interface 410. The various elements are coupled together via a bus 414 over which the various elements may exchange data and information. Wired interface 430 represents a physical network interface and includes a receiver 432 and a transmitter 434. Wired interface 430 may be used, if desired, to couple, either directly or indirectly, UE 400 to a wired network device, such as a switch within the wired network via a cable, such as an Ethernet cable.

First, second, and third wireless interfaces 420a, 420b, and 420c include receivers 422a, 422b, and 422c, respectively, each including a receive antenna via which UE 400 may receive wireless signals from wireless communications devices, such as APs, other UEs, or other devices configured for wireless communication. First, second, and third wireless interfaces 420a, 420b, and 420c further include transmitters 424a, 424b, and 424c, respectively, each including transmit antennas via which UE 400 may transmit wireless signals to wireless communications devices, such as APs, other UEs, and/or other devices configured for wireless communication. In some examples, first wireless interface 420a may include a Wi-Fi 802.11 interface (e.g., 2.4 GHz and/or 5 GHz) and second wireless interface 420b may include a Bluetooth interface and/or a Bluetooth Low Energy interface. Third wireless interface 420c may include, for example, a cellular interface through which UE device 400 may connect to a cellular network.

Processing resources(s) 406 execute software instructions, such as those used to define a software or computer program, stored to computer-readable storage media 412, such as non-transitory computer-readable media including a storage device (e.g., a disk drive, or an optical drive) or a memory (such as Flash memory or RAM) or any other type of volatile or non-volatile memory, that stores instructions to cause the one or more processing resources 406 to perform the techniques described herein.

Computer-readable storage media 412 includes one or more devices configured to store programming units and/or data associated with operation of UE 400. For example, computer-readable storage media 412 may include non-transitory computer-readable media including a storage device (e.g., a disk drive, or an optical drive) or a memory (such as Flash memory or RAM) or any other type of volatile or non-volatile memory, that stores instructions to cause the processing resource(s) 406 to perform the techniques described herein.

In this example, computer-readable storage media 412 includes an operating system 440, applications 442, a communications module 444, configuration settings 450, and data 454. Communications module 444 includes program code that, when executed by processing resource(s) 406, enables UE 400 to communicate using any of wired interface(s) 430, wireless interfaces 420a–420b and/or cellular interface 420c. Configuration settings 450 include any device settings for UE 400 settings for each of wireless interface(s) 420a–420b and/or cellular interface 420c.

As described herein, UE 400 may measure and report data from data 454 to a network management system for further analysis. The data may comprise event data, telemetry data, and/or other SLE-related data. The network data may include various parameters indicative of the performance and/or status of the wireless network. Data 454 may include, for example, a status/error log including a list of events specific to UE 400. The events may include a log of both normal events and error events according to a logging level based on instructions from the network management system. Data 454 may include any data used and/or generated by UE 400, such as data used to calculate one or more SLE metrics or identify relevant behavior data, that is collected by UE 400 and either transmitted directly to the network management system or transmitted to any AP in a wireless network for further transmission to the network management system. In some examples, data 454 may include network and/or device data associated with an application session, such as CPU usage data of UE 400 during the application session, VPN information associated with a VPN session between UE 400 and a VPN server and operating concurrently with the application session, etc. For example, data 454 may include a location of UE 400 for the VPN session between UE 400 and a VPN server. In some examples, data 454 may include a VPN server distance determined based on the location of UE 400 and a location of a VPN server (e.g., server 128A of FIG. 1) for the VPN session between UE 400 and the VPN server.

NMS agent 456 is a software agent of the network management system that is installed on UE 400. In some examples, NMS agent 456 can be implemented as a software application running on UE 400. NMS agent 456 collects information including detailed client-device properties from UE 400. In some examples, NMS agent 456 may display the client-device properties on UE 400. NMS agent 456 sends the client device properties to the network management system, via an AP device to which UE 400 is connected. NMS agent 456 can be integrated into a custom application or as part of location application. NMS agent 456 may be configured to recognize device connection types (e.g., cellular or Wi-Fi), along with the corresponding signal strength. For example, NMS agent 456 recognizes access point connections and their corresponding signal strengths. NMS agent 456 can store information specifying the APs recognized by UE 400 as well as their corresponding signal strengths. NMS agent 456 or other element of UE 400 also collects information about which APs the UE 400 is connected with, which also indicates which APs the UE 400 did not connect with. NMS agent 456 of UE 400 sends this information to the network management system via its connected AP. In this manner, UE 400 sends information about not only the AP that UE 400 is connected with, but also information about other APs that UE 400 recognized and did not connect with, and their signal strengths. The AP in turn forwards this information to the network management system, including the information about other APs the UE 400 recognized besides itself. This additional level of granularity enables the network management system, and ultimately network administrators, to better determine the Wi-Fi experience directly from the client device’s perspective.

In some examples, NMS agent 456 further enriches the client device data leveraged in service levels. For example, NMS agent 456 may go beyond basic fingerprinting to provide supplemental details into properties such as device type, manufacturer, and different versions of operating systems. In the detailed client properties, the network management system can display the radio hardware and firmware information of UE 400 received from NMS client agent 456. The more details the NMS agent 456 can draw out, the better the VNA/AI engine gets at advanced device classification. The VNA/AI engine of the network management system continually learns and becomes more accurate in its ability to distinguish between device-specific issues or broad device issues, such as specifically identifying that a particular OS version is affecting certain clients.

In some examples, NMS agent 456 may cause user interface 410 to display a prompt that prompts an end user of UE 400 to enable location permissions before NMS agent 456 is able to report the device’s location, client information, and network connection data to the network management system. NMS agent 456 may then start reporting connection data to the network management system along with location data. In this manner, the end user of the client device can control whether the NMS agent 456 is enabled to report client device information to the network management system.

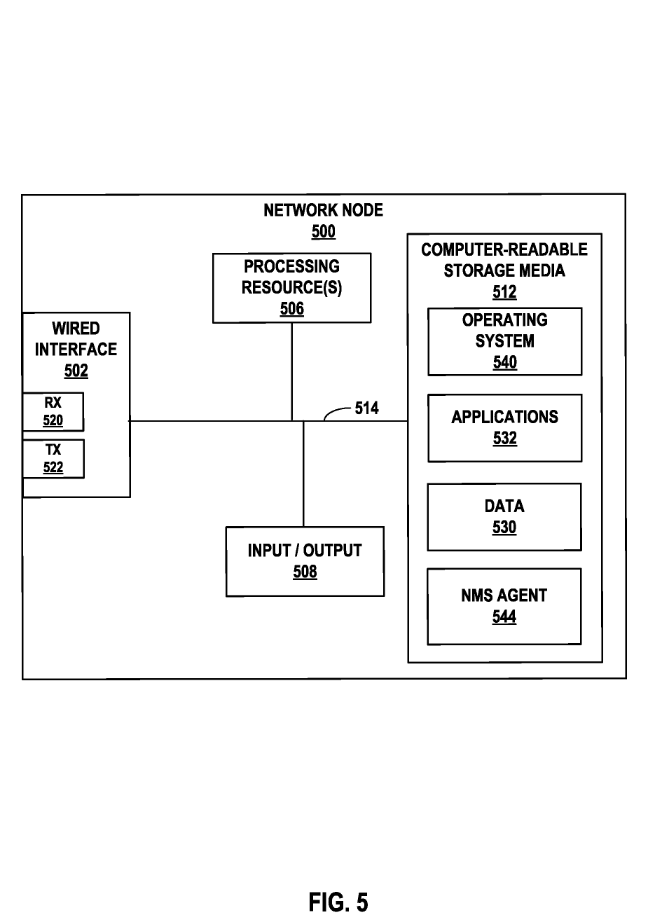

FIG. 5 is a block diagram illustrating an example network node 500 configured according to the techniques described herein. In one or more examples, the network node 500 is an example implementation of a device or a server attached to the network 134 of FIG. 1, e.g., switches 146, AAA server 110, DHCP server 116, DNS server 122, web servers 128, etc.

In this example, network node 500 includes a wired interface 502, e.g., an Ethernet interface, one or more processing resource(s) 506, input/output 508 (e.g., display, buttons, keyboard, keypad, touch screen, mouse, etc.), and computer-readable storage media 512 coupled together via a bus 514 over which the various elements may interchange data and information. Wired interface 502 couples the network node 500 to a network, such as an enterprise network. Though only one interface is shown by way of example, network nodes may, and usually do, have multiple communication interfaces and/or multiple communication interface ports. Wired interface 502 includes a receiver 520 and a transmitter 522.

Computer-readable storage media 512 stores executable software applications 532, operating system 540 and data 530. Data 530 may include a system log and/or an error log that stores event data, including behavior data, for network node 500. In some examples, data 530 may include the location of network node 500 (e.g., operating as a VPN server) for a given VPN session. In some examples, data 530 may include a VPN server distance determined based on the location of network node 500 and a location of a client device (e.g., UE 148a-1 of FIG. 1) for a given VPN session between network node 500 and the client device.

In examples where network node 500 comprises a server, network node 500 may receive data and information, e.g., including operation related information, e.g., registration request, AAA services, DHCP requests, Simple Notification Service (SNS) look-ups, and Web page requests via receiver 520, and send data and information, e.g., including configuration information, authentication information, web page data, etc. via transmitter 522.

In examples where network node 500 comprises a wired network device, network node 500 may be connected via wired interface 502 to one or more APs or other wired client-side devices, e.g., IoT devices, within a wired network edge. For example, network node 500 may include multiple wired interfaces 502 and/or wired interface 502 may include multiple physical ports to connect to multiple APs or the other wired-client-side devices within a site via respective Ethernet cables. In some examples, each of the APs or other wired client-side devices connected to network node 500 may access the wired network via wired interface 502 of network node 500. In some examples, one or more of the APs or other wired client-side devices connected to network node 500 may each draw power from network node 500 via the respective Ethernet cable and a Power over Ethernet (PoE) port of wired interface 502.

In examples where network node 500 comprises a session-based router that employs a stateful, session-based routing scheme, network node 500 may be configured to independently perform path selection and traffic engineering. The use of session-based routing may enable network node 500 to eschew the use of a centralized controller, such as an SDN controller, to perform path selection and traffic engineering, and eschew the use of tunnels. In some examples, network node 500 may implement session-based routing in accordance with Secure Vector Routing (SVR). In the case where network node 500 comprises a session-based router operating as a network gateway for a site of an enterprise network, network node 500 may establish multiple peer paths over an underlying physical WAN with one or more other session-based routers operating as network gateways for other sites of the enterprise network. Network node 500, operating as a session-based router, may collect data at a peer path level, and report the peer path data to the network management system.

In examples where network node 500 comprises a packet-based router, network node 500 may employ a packet- or flow-based routing scheme to forward packets according to defined network paths, e.g., established by a centralized controller that performs path selection and traffic engineering. In the case where network node 500 comprises a packet-based router operating as a network gateway for a site of an enterprise network, network node 500 may establish multiple tunnels over an underlying physical WAN with one or more other packet-based routers operating as network gateways for other sites of the enterprise network. Network node 500, operating as a packet-based router, may collect data at a tunnel level, and the tunnel data may be retrieved by the network management system via an API or an open configuration protocol or the tunnel data may be reported to the network management system by NMS agent 544 or other module running on network node 500.

The data collected and reported by network node 500 may include periodically-reported data and event-driven data. Network node 500 is configured to collect logical path statistics via bidirectional forwarding detection (BFD) probing and data extracted from messages and/or counters at the logical path (e.g., peer path or tunnel) level. In some examples, network node 500 is configured to collect statistics and/or sample other data according to a first periodic interval, e.g., every 3 seconds, every 5 seconds, etc. Network node 500 may store the collected and sampled data as path data, e.g., in a buffer. In some examples, NMS agent 544 may periodically create a package of the statistical data according to a second periodic interval, e.g., every 3 minutes. The collected and sampled data periodically reported in the package of statistical data may be referred to herein as “oc-stats.”

In some examples, the package of statistical data may also include details about clients connected to network node 500 and the associated client sessions. NMS agent 544 may then report the package of statistical data to NMS 130 in the cloud. In other examples, the network management system may request, retrieve, or otherwise receive the package of statistical data from network node 500 via an API, an open configuration protocol, or another of communication protocols. The package of statistical data created by NMS agent 544 or another module of network node 500 may include a header identifying network node 500 and the statistics and data samples for each of the logical paths from network node 500. In still other examples, NMS agent 544 reports event data to the network management systemin the cloud in response to the occurrence of certain events at network node 500 as the events happen. The event-driven data may be referred to herein as “oc-events.”

In some examples, network node 500 may measure and report network data associated with an application session to the network management system. For example, network node 500 may exchange data for a cloud-based application during an application session (e.g., application session 160 of FIG. 1) and may measure and report network data from data 530 that was measured during the application session. For instance, network node 500 may measure network data such as jitter, transmission bytes, or other network data during the application session, and send the network data associated with the application session to the network management system.

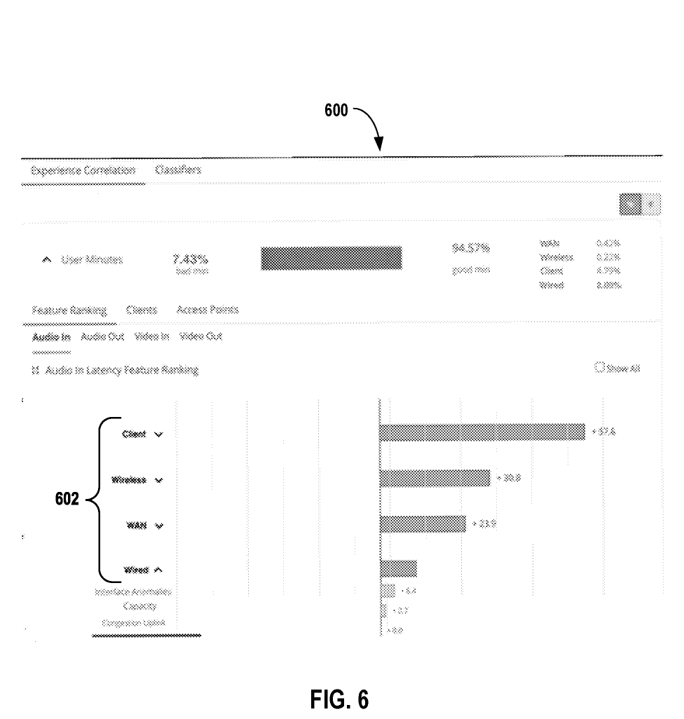

FIG. 6 illustrates an example user interface, in accordance with the techniques of this disclosure. User interface 600 may represent an example user interface for display on a display device of admin device 111 of FIG. 1 and/or user interface 310 of network management system 300 of FIG. 3.

In the example of FIG. 6, the network management system may generate user interface 600 that includes one or more UI elements representing the one or more features determined to be the root cause of an issue of an application session and/or predicted application performance metric. For example, user interface 600 includes one or more UI elements representing features 602 of client devices, of devices in a wireless network (e.g., APs), of devices in a WAN network (e.g., gateway devices), and/or of a wired network (e.g., switches, routers, etc.) that may be a root cause of an issue to an application session, such as latency of audio in of an application session.

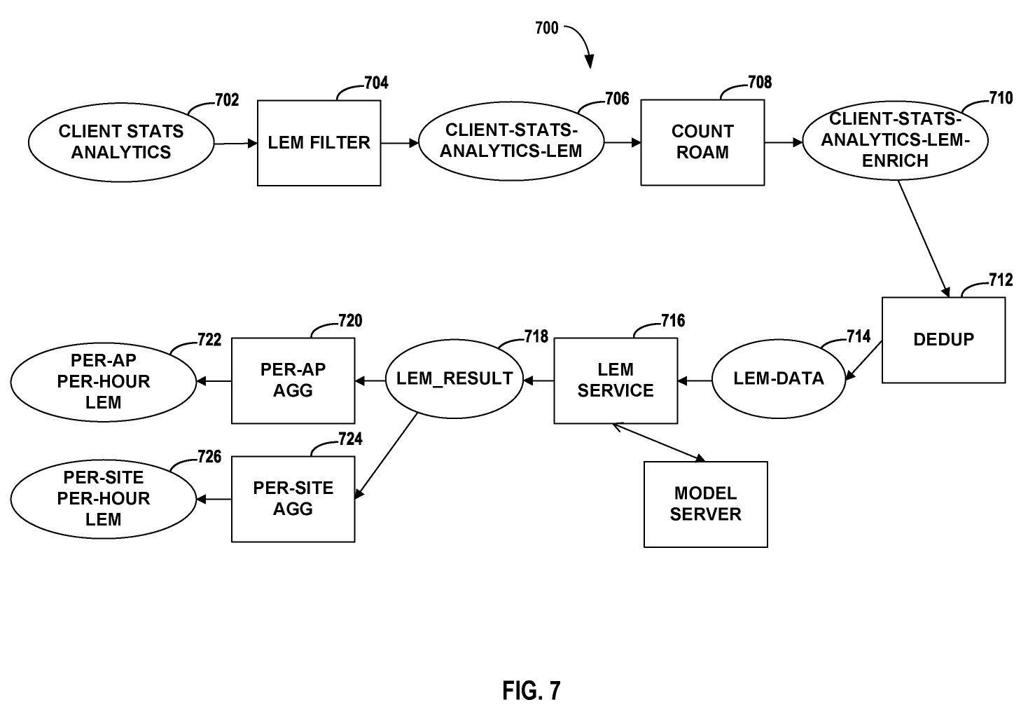

FIG. 7 illustrates a block diagram of an example a backend pipeline of the application performance prediction engine, in accordance with the techniques of this disclosure. Once the application performance ML model(s) of the network management system are trained, such as the application performance ML model(s) described in FIGS. 3A and 3B, it may be deployed within the LEM backend pipeline 700 as “LEM service” and “model server,” as illustrated in FIG. 7 to provide per-AP and per-site analytics of customer network data.

In the example of FIG. 7, LEM backend pipeline 700 receives a plurality of data streams (illustrated as “Client Stats Analytics”) across various applications and devices, such as applications hosted on application servers, APs, switches, etc. (702). Each of these data streams may include different metrics and categories of data, and may be organized according to different schemas. The LEM filter correlates and aggregates this data according to different organizations and sites (704). The aggregated data set is enriched, such as with client roaming and channel change metrics, which may be used as an additional data point for evaluation by the application performance ML model(s) described above. For example, the aggregated data set (“client-stats-analytics-lem”) is enriched with client roaming metrics (708) to generate enriched data (710) (“client-status-analytics-lem-enrich”). In addition, de-duplication is performed to remove duplicates from the aggregated data set (712) (illustrated as “lem-data”).

The aggregated data set (“lem-data”) is provided to application performance ML model(s) (716) (illustrated as “LEM service”). In some examples, the LEM service receives real-time data and performs real-time inferencing. The LEM service generates one or more Shapley values (718) (illustrated as “lem_result”), which are aggregated (720 and 724, respectively) into two aggregated data sets: a per-AP data set (722) and a per-site data set (726). A network management system (e.g., NMS 130 of FIG. 1) may correlate reports of poor user experience to Shapley values at a same time interval to identify a root cause of the poor user experience issue, so as to identify a site or AP that may be correlated to or causing the poor user experience issue.

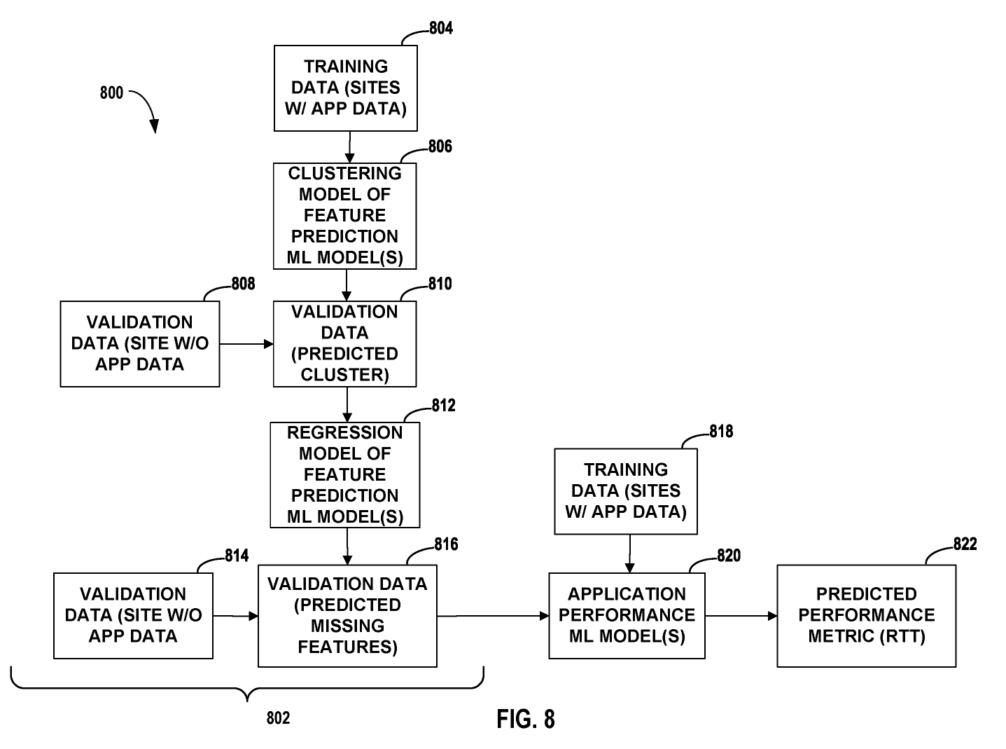

FIG. 8 illustrates a block diagram of an example operation to predict one or more application performance metrics of an application session for a site without application data, in accordance with one or more techniques of the disclosure. Operation 800 may be an example operation of application performance prediction engine 135 and feature prediction unit 136 of NMS 130 from FIG. 1 and/or application performance prediction engine 352 and feature prediction unit 354 of NMS 300 from FIG. 3A.

In the example of FIG. 8, a feature prediction unit may estimate a value of one or more features of a site without application data (802). For example, the feature prediction unit may obtain data of a site with application data, such as network data of devices in a site that are associated with an application session (804). The feature prediction unit may apply a clustering model of one or more feature prediction ML model (806) to determine whether data of a site that does not have application data (808) is to be clustered with data of the site with application data. Based on determining that data of the site without application data and data of the site with application data belong to the same cluster (810), the feature prediction unit may estimate a value for one or more features of the site without application data based on data of the site with application data. For example, the feature prediction unit may apply a regression model of the one or more feature prediction ML models including a target variable for estimating a value of a feature of the site without application data (812).

The feature prediction unit may apply features generated from network data of the site without application data (814) and one or more estimated features (816) to a predictive model as input to application performance ML model(s). For instance, a feature (e.g., feature 386a of FIG. 3B) may include an RSSI value indicating the signal strength of a user equipment device of a site without application data connected to an access point, an estimated feature (e.g., estimated feature 387 of FIG. 3B) may include an estimated value of CPU usage of the user equipment device of the site without application data during an application session, and so on, and each of the features and estimated feature(s) are input into the application performance ML model(s) to predict an application performance metric of an application session for a site without application data (822). The application performance ML model(s) may be trained based on data of a site with application data (818). For example, the application performance ML model(s) may include a target variable for predicting an application performance metric (e.g., round-trip time (RTT)) (820) and is trained based on data of a site with application data (e.g., network data of devices in site 102a associated with application session 160 and application performance data associated with application session 160).

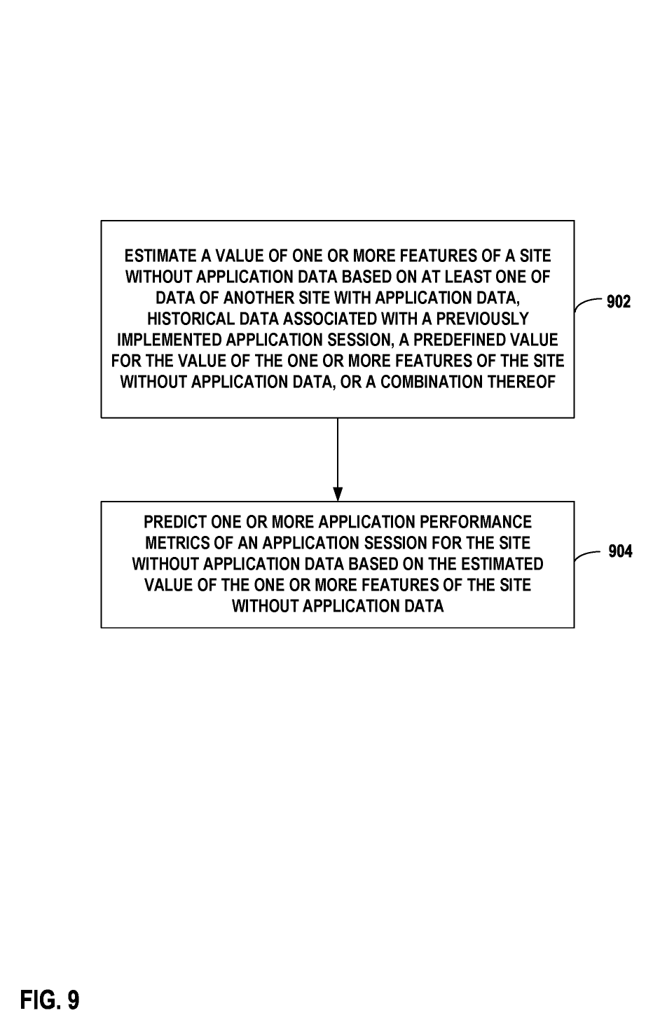

FIG. 9 is a flowchart of an example operation of a network management system to predict one or more application performance metrics of an application session for a site without application data, in accordance with one or more techniques of the disclosure. The example operation of FIG. 9 may be an example operation of NMS 130 of FIG. 1 and/or NMS 300 of FIG. 3A.

In the example of FIG. 9, a network management system may estimate a value of one or more features of a site without application data based on at least one of data of another first site with application data, historical data associated with a previously implemented application session, a predefined value for the value of the one or more features of the site without application data, or a combination thereof (902). For example, the network management system may obtain data of a site with application data, such as network data of devices in the site that are associated with an application session. The network management system may apply a clustering model of one or more feature prediction ML models to determine whether data of a site without application data is to be clustered with data of the site with application data. Based on determining that data of the site without application data and data of the site with application data belong to the same cluster, the network management system may estimate a value for one or more features of the site without application data based on data of the site with application data. For example, the network management system may apply a regression model of the one or more feature prediction ML models including a target variable for estimating a value of a feature of the site without application data. In some examples, the network management system may estimate a value of the one or more features of the site without application data based on historical data associated with a prior application session, such as application data associated with one or more previously implemented application sessions. In some examples, the network management system may specify predefined values for the one or more features of the site without application data, where the predefined values are indicative of a presumed performance of an application session (e.g., values indicative of an application session operating at optimal and/or normal conditions).

The network management system may predict one or more application performance metrics of an application session for the site without application data based on the estimated value of the one or more features of the site without application data (904). For example, the network management system may provide the estimated values for the features and one or more other features (e.g., features corresponding to network data unassociated with an application session and obtained from the site without application data) to one or more application performance ML models, which in turn determine one or more application performance metrics of an application session that may be implemented by devices of the site without application data. The application performance ML model(s) may be trained based on network data and application performance data of one or more sites with application data obtained over a first period of time. In some examples, the network management system may determine a predicted issue with the application session for the site without application data based on the predicted one or more application performance metrics of the application session for the site without application data.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processing resources, rather than sequentially. Further, certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

Although various Figures are referenced herein in connection with the description of one or more specific examples, such examples are merely illustrative, and each Figure can be used to provide support for other examples not specifically described herein. Accordingly, the one or more examples described herein with reference to a specific Figure should not be construed to narrow the scope or spirit of the subject matter illustrated in that Figure or any other illustration.

In the preceding description, references may be occasionally made to “some examples.” In this disclosure, a reference to “some examples” is intended to mean a subset of all of the possible examples supported by this disclosure. Also, different references to “some examples” are not always a reference to the same subset of examples.

For ease of illustration, only a limited number of systems are shown within the illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The illustrations included herein depict at least one example implementation of an aspect of this disclosure. The scope of this disclosure is not, however, limited to such implementations. Accordingly, other example or alternative implementations of systems, methods or techniques described herein, beyond those illustrated, may be used in other instances. Such implementations may include a subset of the devices and/or components included in the illustrations and/or may include additional devices and/or components not specifically illustrated.

The description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, known structures and components are shown in block diagram form in the referenced illustrations in order to avoid obscuring such concepts.

Accordingly, although one or more implementations of various systems, devices, and/or components may be described with reference to specific illustrations, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated herein may alternatively be implemented as part of another device or component not shown in such illustrations. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner. Any references herein to “real time” or equivalent phrases are intended to encompass near-real time or seemingly near-real time, such as from the perspective of a reasonable human observer.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory computer-readable storage media or (2) a communication medium such as a signal or carrier wave. Data storage media may be any available media that can be accessed by one or more computers or one or more processing resources to retrieve instructions, code and/or data structures for implementation of the techniques described in this disclosure. A computer program product may include a computer-readable medium.

By way of example, and not limitation, such computer-readable storage media can include random-access memory (RAM), read-only memory (ROM), non-volatile random-access memory (NVRAM), electrically erasable programmable read-only memory (EEPROM), Flash memory, optical data storage media, magnetic disk storage, or other magnetic storage devices, Solid-State Drive (SSD) storage, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium.

Instructions may be executed by one or more processing resources, such as one or more Central Processing Units (CPUs), Graphics Processing Units (GPUs), Digital Signal Processors (DSPs), microprocessors, controllers, Application-Specific Integrated Circuits (ASICs), Field-Programmable Gate Arrays (FPGAs), quantum processors, or other equivalent integrated or discrete logic circuitry. One or more processing resources may be, may be part of, and/or may include processing circuitry that performs operations in accordance with one or more aspects of the present disclosure. The terms “processing resource,” “processor,” or “processing circuitry” as used herein may each refer to any of the foregoing structure or any other structure suitable for implementation of the techniques described. In addition, in some examples, the functionality described may be provided within dedicated hardware and/or software modules. One or more processing resources of a computing system may implement functionality and/or execute instructions associated with the computing system or associated with one or more modules illustrated herein and/or described herein. Also, the techniques could be fully implemented in one or more circuits or logic elements.

Where a phrase similar to “at least one of A, B, and C” is used in the claims, it is intended that the phrase be interpreted to mean that A alone may be present; B alone may be present; C alone may be present; or that any combination of the elements A, B, and C may be present, for example, A and B, A and C, B and C, or A and B and C.

Where a phrase similar to “one or more processing resources configured to X, Y, and Z” is used in the claims, it is intended that the phrase be interpreted to mean at least: that a first processing resource alone may perform functions X, Y, and Z; that two or more processing resources (e.g., processors A and B) may collectively perform functions X, Y, and Z; that a first processing resource may perform functions X and Y and a second processing resource may perform function Z; or that a first processing resource may perform function X, a second processing resource may perform function Y, and a third processing resource may perform function Z. Furthermore, the phrase “instructions executable by the one or more processing resources to cause the computing system to” or similar phrase is intended to encompass functions performed by the computing system and resulting from the execution of the instructions by any combination of the one or more the processing resources.

The techniques of this disclosure may be implemented in a wide variety of devices or apparatuses, including, to the extent appropriate, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processing resources as described above, in conjunction with suitable software and/or firmware.

What is claimed is:

1. A network management system comprising:
one or more processing resources; and
one or more computer-readable storage media comprising instructions executable by the one or more processing resources to cause the network management system to:
estimate, based on data of a first site with application data, a value of one or more features of a second site without application data; and
predict, based on the estimated value of the one or more features of the second site, one or more application performance metrics of an application session for the second site.

2. The network management system of claim 1, wherein to estimate the value of the one or more features of the second site, the one or more processing resources are configured to:
apply a clustering model to the data of the first site and the data of the second site; and
based on determining that the data of the first site and the data of the second site belong to a cluster, estimate the value of the one or more features of the second site based on data of the first site.

3. The network management system of claim 1, wherein to estimate the value of the one or more features of the second site, the instructions cause the network management system to set the one or more features of the second site as a target variable for a regression model.

4. The network management system of claim 1, wherein the data of the first site comprises data associated with an application session implemented by one or more devices of the first site.

5. The network management system of claim 4, wherein the data associated with the application session implemented by one or more devices of the first site comprises at least one of signal strength, jitter, transmission bytes, radio utilization, total number of clients per access point, number of access points per site, central processing unit (CPU) utilization of a client device, information associated with a virtual private network session (VPN), or a combination thereof.

6. The network management system of claim 1, wherein the data associated with the application session comprises application performance data including at least one of latency, bandwidth, audio in, audio out, video in, video out, screen share in, screen share out, packet loss, bit rate, resolution, frames per second, user feedback, or a combination thereof.

7. The network management system of claim 1, wherein the instructions further cause the network management system to:
estimate the value of the one or more features based on historical data associated with a previously implemented application session.

8. The network management system of claim 1, wherein the instructions further cause the network management system to:
specify a predefined value for the value of the one or more features of the second site.

9. The network management system of claim 8, wherein the predefined value is indicative of a presumed performance of the application session.

10. The network management system of claim 1, wherein the instructions further cause the network management system to:
determine, based on the predicted one or more application performance metrics of the application session for the second site, a predicted issue with the application session for the second site.

11. A method comprising:
estimating, by a network management system, a value of one or more features of a site without application data based on at least one of data of another site with application data, historical data associated with a previously implemented application session, a predefined value for the value of the one or more features of the site without application data, or a combination thereof; and
predicting, by the network management system, one or more application performance metrics of an application session for the site without application data based on the estimated value of the one or more features of the site without application data.

12. The method of claim 11, wherein estimating the value of the one or more features of the site without application data comprises:
applying a clustering model to the data of the site with application data and the data of the site without application data; and
based on determining that the data of the site with application data and the data of the site without application data belong to a cluster, estimating the value of the one or more features of the site without application data based on data of the site with application data.

13. The method of claim 11, wherein estimating the value of the one or more features of the site without application data comprises setting the one or more features of the site without application data as a target variable for a regression model.

14. The method of claim 11, wherein the data of the site with application data comprises data associated with an application session implemented by one or more devices of the site with application data.

15. The method of claim 14, wherein the data associated with the application session comprises network data of one or more network devices associated with the application session, the network data including at least one of signal strength, jitter, transmission bytes, radio utilization, total number of clients per access point, number of access points per site, central processing unit (CPU) utilization of a client device, information associated with a virtual private network session (VPN), or a combination thereof.

16. The method of claim 11, wherein the data associated with the application session comprises application performance data including at least one of latency, bandwidth, audio in, audio out, video in, video out, screen share in, screen share out, packet loss, bit rate, resolution, frames per second, user feedback, or a combination thereof.

17. The method of claim 11, wherein the predefined value is indicative of a presumed performance of the application session.

18. The method of claim 11, further comprising:
based on the predicted one or more application performance metrics of the application session for the site without application data, determining, by the network management system, a predicted issue with the application session for the site without application data.

19. The method of claim 18, further comprising:
in response to determining the predicted issue with the application session for the second site, performing, by the network management system, an action prior to implementing the application session to proactively remedy the predicted issue with the application session for the second site.

20. Non-transitory computer-readable storage media comprising instructions executable by processing circuitry to cause a network management system to:
estimate a value of one or more features of a site without application data based on at least one of data of another site with application data, historical data associated with a previously implemented application session, a predefined value for the value of the one or more features of the site without application data, or a combination thereof;
predict one or more application performance metrics of an application session for the site without application data based on the estimated value of the one or more features of the site without application data; and
based on the predicted one or more application performance metrics of the application session for the site without application data, determine a predicted issue with the application session for the site without application data.
